(19) United States
(12) Patent Application Publication
(10) Pub. No.: US 2012/0009050 A1
(43) Pub. Date: Jan. 12, 2012

(54) OFF-ROAD VEHICLE LOADING/UNLOADING DEVICE SUPPORTED BY TRAILER HITCH

(76) Inventor: Donald M. PEPIN, Milan, NH (US)

(21) Appl. No.: 12/833,317

(22) Filed: Jul. 9, 2010

(51) Int. Cl. B60P 1/43

(52) U.S. Cl. 414/537; 414/813

(57) ABSTRACT

A loading/unloading device for attachment to a trailer hitch receive of a vehicle. The loading/unloading device comprises a main frame which has a leading section sized to matingly engage with the trailer hitch receiver of the trailer hitch and a ramp pivotly attached to the main frame such that a first portion of the ramp can, during use, matingly engage with a tailgate of a vehicle while the second opposed end of the ramp can engage with the ground surface. A removable adjustable member is located between the ramp and the main frame for transferring weight from the ramp onto the main frame as an off-road vehicle is loaded and unloaded from a vehicle using the loading/unloading device.

### FIELD OF THE INVENTION

The present invention relates to a loading/unloading device which is secured to a trailer hitch receiver of a transport vehicle to facilitate both loading and unloading of an off-road vehicle, such as a four-wheeler, a three-wheeler, a snowmobile, etc.

### BACKGROUND OF THE INVENTION

Off road vehicles, such as all terrain vehicles, three-wheelers, snowmobiles, or even motorcycles, are commonly transported from a place of storage to a location of use in the bed of a pick-up truck and all of which are collectively hereinafter referred to as an “off-road vehicle.” The problem is that loading and unloading these heavy machines between the ground and the elevated height of the bed of the truck can be a cumbersome and dangerous process. A common method for loading these machines is to lay two metal ramps, each approximately one foot in width and about six to eight feet in length, each with a first lip end resting on an open tailgate and a second end resting on the ground. This method is advantageous in that the ramps are relatively inexpensive and easily maneuverable. The disadvantages with this method is that it is potentially very dangerous in that firstly, the ramps can shift toward or away from one another during the loading process and secondly, their narrow width provides very little room for error such that operators can easily unintentionally drive off the ramps while loading or unloading an off-road vehicle, and finally, the tail-gate of the truck bears the weight of the off-road vehicle as it travels up the ramp, and the tailgate could become damage or fail during the loading or unloading process.

A contrasting method is to use a mechanized lifting device, such as those commonly referred to as Tommy-Gates. This method has the advantages of providing a wide base to drive onto, is securely attached to the truck so it will not shift under the operator when the operator is loading the off-road vehicle, and carries the weight of the loading vehicle on the frame of the truck. The disadvantages of this method is that it is relatively expensive and can only be attached and detached from the truck by expended substantial time and effort.

Finally, some towable trailers are themselves equipped with side ramps for loading and unloading vehicles, but such trailers does not readily allow an off-road vehicles to be loaded and unloaded onto the bed of the truck.

### SUMMARY OF THE INVENTION

Wherefore, it is an object of the present invention to overcome the above mentioned shortcomings and drawbacks associated with the prior art.

Another object of the present invention is to provide a relatively secure device and method for loading and unloading an off-road vehicle between the ground and the bed of a truck, that carries the weight of the off-road vehicle on the frame of the truck during loading, is easily detachable from the truck, and can be easily towed behind the truck for unloading the off-road vehicle after transit.

The present invention also relates to a loading/unloading device for attachment to a trailer hitch receiver of a transport vehicle, the loading/unloading device comprising: a main frame having a leading section which is sized to matingly engage with the trailer hitch receiver of the trailer hitch; a loading/unloading ramp pivotly attached to the main frame by a main hinge such that a first portion of the loading/unloading ramp can, during use, matingly engage with a tailgate of the transport vehicle while the second opposed end of the loading/unloading ramp can engage with a ground surface; and an adjustable member located between the loading/unloading ramp and the main frame for transferring weight from the loading/unloading ramp onto the main frame as an off-road vehicle is loaded onto or unloaded from the transport vehicle using the loading/unloading device.

The present invention also relates to a method of loading/unloading an off-road vehicle using an loading/unloading device attached to a trailer hitch receiver of a transport vehicle, the method comprising the steps of: sizing a leading section of a main frame to have a size which matingly engages with the trailer hitch receiver of the trailer hitch; pivotally attaching a loading/unloading ramp to the main frame via a main hinge such that a first portion of the loading/unloading ramp can, during use, matingly engage with a tailgate of the transport vehicle while the second opposed end of the loading/unloading ramp can engage with a ground surface; positioning an adjustable member between the loading/unloading ramp and the main frame; and transferring weight of the off-road vehicle from the loading/unloading ramp onto the main frame as the off-road vehicle is loaded onto or unloaded from the transport vehicle using the loading/unloading device.

### BRIEF DESCRIPTION OF THE DRAWINGS

The invention will now be described, by way of example, with reference to the accompanying drawings in which:

FIG. 1 is a diagrammatic side elevational view showing the loading/unloading device, according to the present invention, attached to a receiver of a transport vehicle;

FIGS. 2A-2C are respectively diagrammatic top plan views showing different configurations for the loading/unloading ramp of the loading/unloading device, according to the present invention;

FIG. 3 is a diagrammatic side elevational view of the loading/unloading device shown in its fully deployed position;

FIG. 4 is a diagrammatic side elevational view of the loading/unloading device of FIG. 1 shown in a partially stored position;

FIG. 5 is a diagrammatic side elevational view of the loading/unloading device of FIG. 1 shown in a completely stored position; and

FIG. 6 is a diagrammatic top plan view of the main frame of the loading/unloading device of FIG. 1.

### DETAILED DESCRIPTION OF THE INVENTION

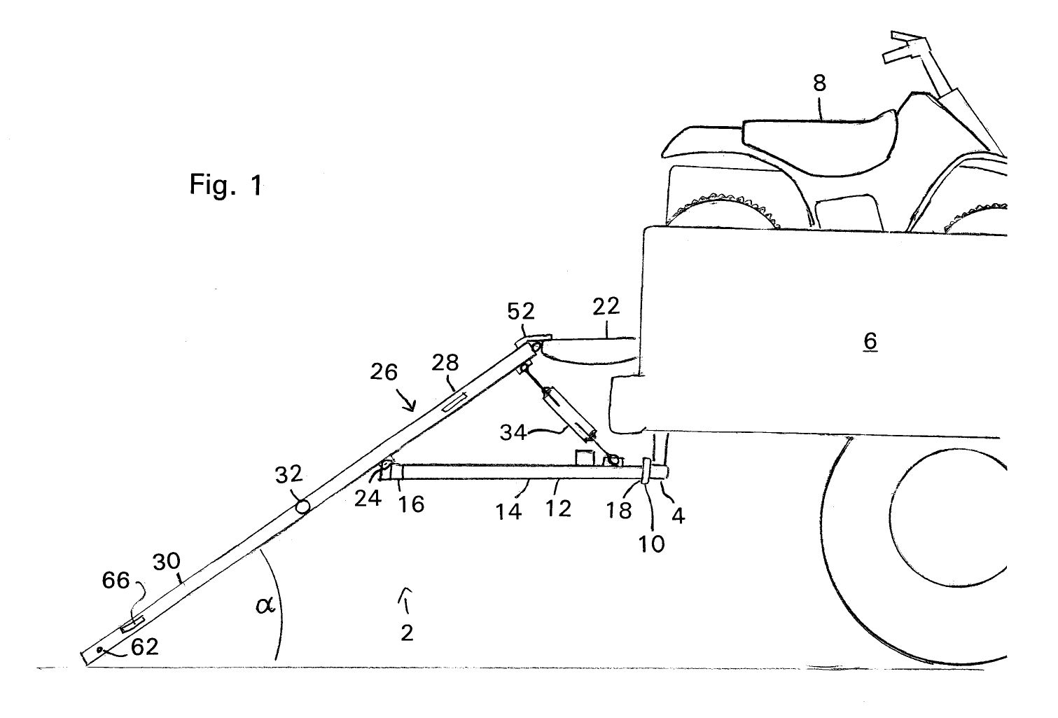

With reference now to FIGS. 1-6, a detailed description concerning the loading/unloading device 2 of the present invention will not be provided. As can be seen in FIGS. 1 and 3-5, for example, the loading/unloading device 2 is generally supported via a trailer hitch receiver 4 which is affixed to a rear end of a desired transport vehicle 6, such as a pick-up truck or some other utility vehicle, for transporting an off-road vehicle 8 (only partially shown), such as a four-wheeler, a three-wheeler, a snowmobile, a motorcycle, etc., to and from a desired destination. The trailer hitch receiver 4 is installed in a conventional manner on the desired transport vehicle 6 and generally has a receiver opening 10 that is generally approximately 2″ by 2″ in size. It is to be appreciated that the size of the receiver opening 10 can vary, depending upon the size and type of the trailer hitch receiver 4, but typically ranges from at least approximately ¾″ by ¾″ to approximately 4″ by 4″ in size.

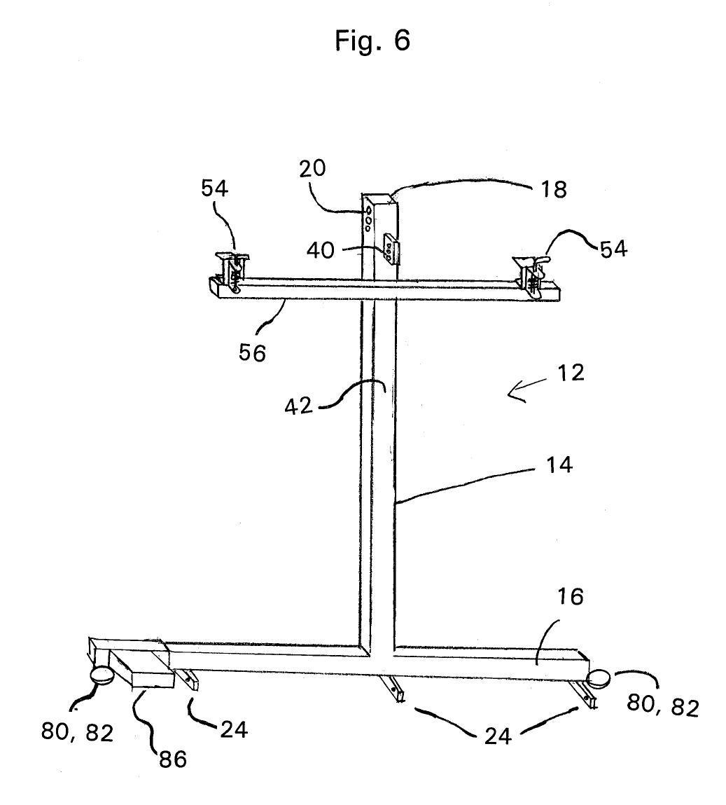

As can be seen in FIG. 6, for example, the loading/unloading device 2 generally comprises a T-shaped main frame 12 having a central longitudinal beam 14 permanently connected, e.g., by welding for example, with an intermediate section of a transverse beam 16. The longitudinal beam 14 typically has a length of between about 60 and about 36 inches and is preferably about 48 inches in length. The transverse beam 16 typically has a length of between about 72 and about 30 inches and is preferably about 34 inches in length. Both the longitudinal beam 14 and the transverse beam 16 provide sufficient support and structural integrity for the loading/unloading device 2. Typically both the longitudinal beam 14 and the transverse beam 16 are each generally a 2 inch by 2 inch hollow steel beam which provides sufficient support for the loading/unloading ramp 26 of the loading/unloading device 2 during loading and unloading of a desired off-road vehicle 8, as will be described in further detail below, and sized to be received within the receiver opening 10 of the trailer hitch receiver 4.

A leading or forward most end portion 18 of the longitudinal beam 14 has one or more through holes 20, e.g., between about ¼ inch to about 1 inch in size, which pass longitudinal through both opposed side walls of the longitudinal beam 14. Once the leading end portion 18 of the longitudinal beam 14 is received within the receiver opening 10 of the trailer hitch receiver 4 of a desired transport vehicle 6, one of the longitudinal through holes 20 is aligned with the conventional aperture (not shown) of the trailer hitch receiver 4, which is typically also between about ¼ inch to about 1 inch in size, and a conventional securing pin or the like (not shown) passes through to the aligned through hole 20 of the longitudinal beam 14 and the aperture of the trailer hitch receiver 4 to secure the longitudinal beam 14 to the trailer hitch receiver 4 in a conventional fashion. The purpose of the through holes 20 in the longitudinal beam 14 is to precisely align the loading/unloading device 2 with a tailgate 22 of the transport vehicle 6, as will be discuss further below in further detail.

A first portion of one or more main hinges 24 is supported at the mid-point and at adjacent each opposed end of the traverse beam 16 while a second mating portion of each one of the main hinges 24 is supported by a midsection of an undersurface 38 of the loading/unloading ramp 26. The main hinges 24 allow the loading/unloading ramp 26 to pivot relative to the main frame 12, and further detail discussion concerning the purpose and function of the same will follow below.

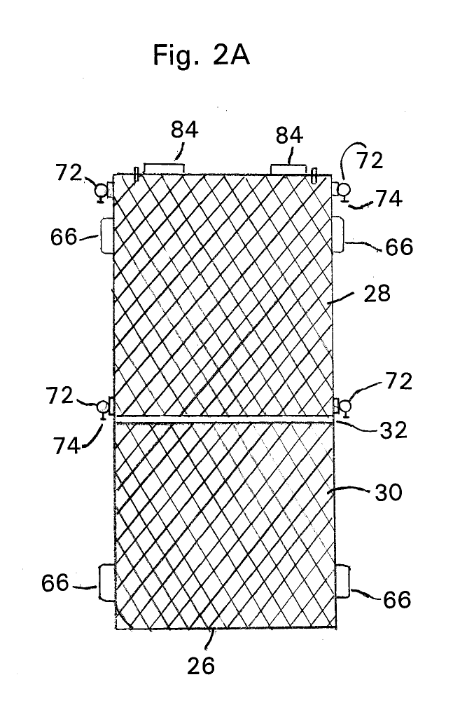

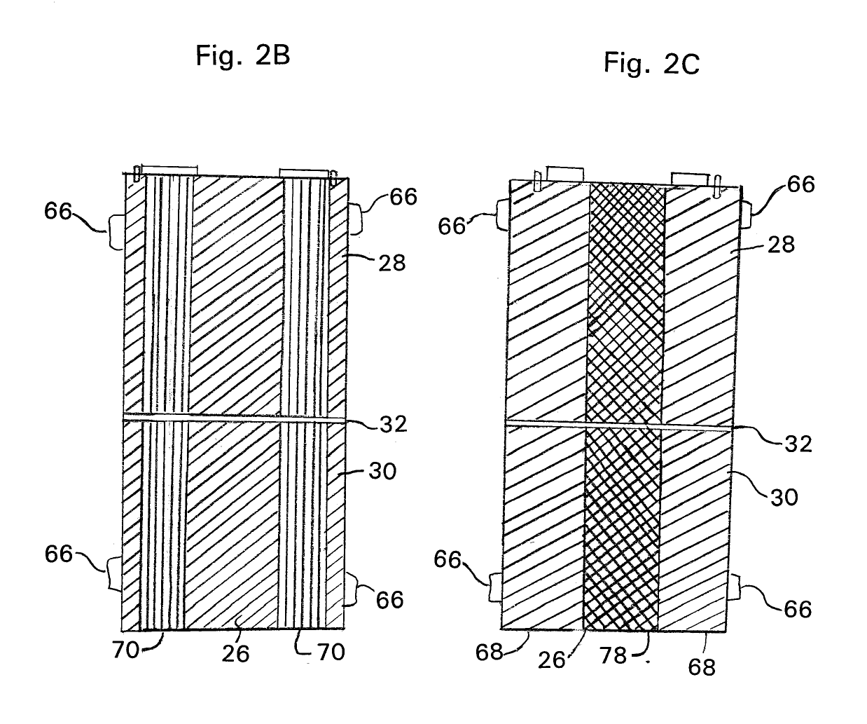

As shown in FIGS. 2A-2C, the loading/unloading ramp 26 generally comprises a rectangular platform which includes a first ramp section 28 and a second ramp section 30, although it is conceivable that the loading/unloading ramp 26 can comprise a single unhinged ramp surface if so desired. The loading/unloading ramp 26 generally has a total axial length of between about 120 and about 60 inches or so, more preferably a length of about 79 inches, and has a width of between about 72 and about 36 inches or so, more preferably a width of about 60 inches or so. It is to be appreciated that the overall length and the width of the loading/unloading ramp 26 can vary, from application to application, depending upon the type of off-road vehicle 8 to be loaded and unloaded onto the transport vehicle 6 by the loading/unloading device 2 as well as the vertical height from the ground of carrying bed of the transport vehicle 6. In order to ensure safe loading and unloading of the off-road vehicle 8, the inclination angle α (FIG. 1) of the loading/unloading ramp 26 must not be too steep as this can to cause an unsafe loading and unloading condition, i.e., the inclination angle α should be about 40 degrees or less, typically about 32 degrees or so.

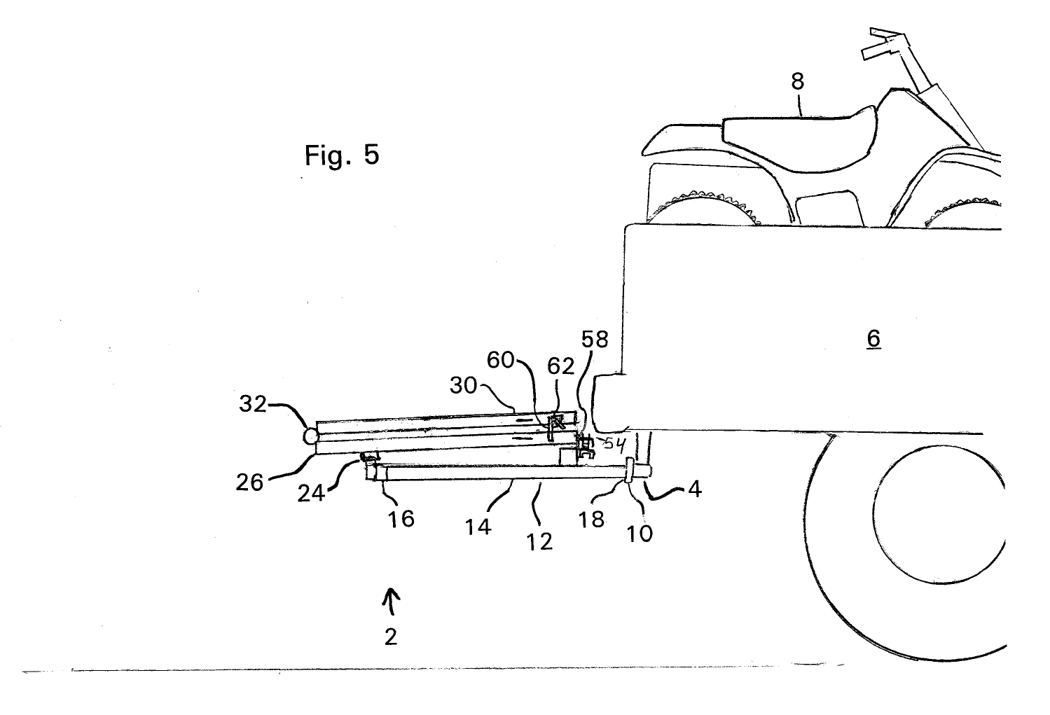

As noted above, the loading/unloading ramp 26 generally comprises the first ramp section 28 and the second section 30 which are both hingedly connected together with one another along adjacent longitudinal edges of the first and the second ramp sections 28, 30 by either a single elongate ramp hinge 32 or two or more spaced apart ramp hinges 32. The ramp hinge(s) 32 facilitate folding of the second ramp section 30 onto the first section into the partially stored position (shown in FIG. 4) or the completely stored position (shown in FIG. 5), as will be describe below in further detail. As shown in FIGS. 2A-2C, the first ramp section 28 is generally slightly larger in overall size than the second ramp section 30 but this feature is not critical.

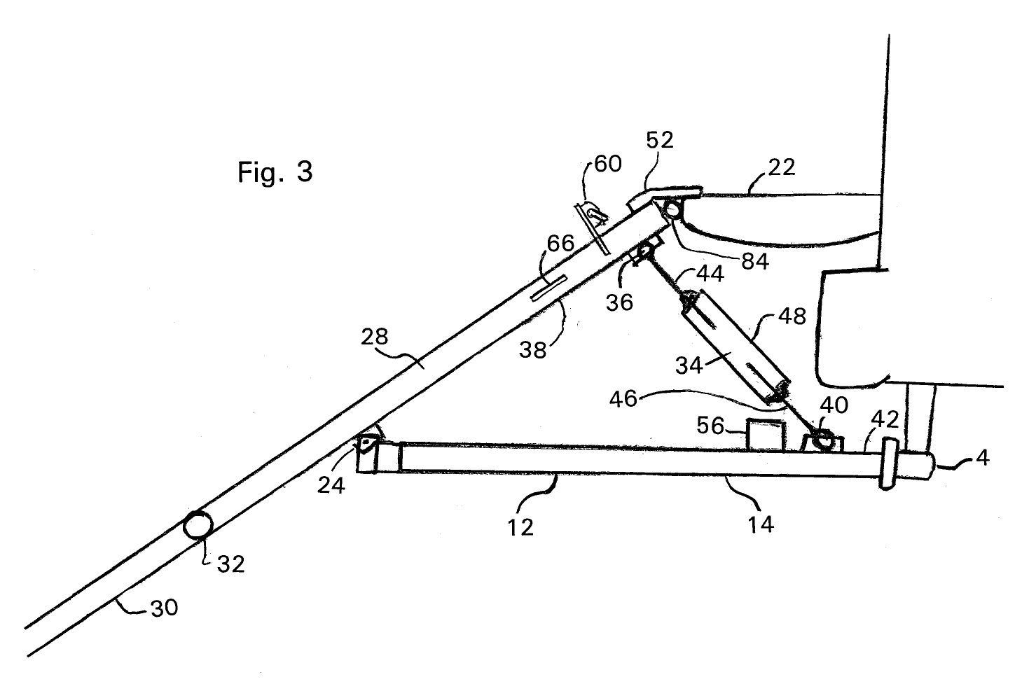

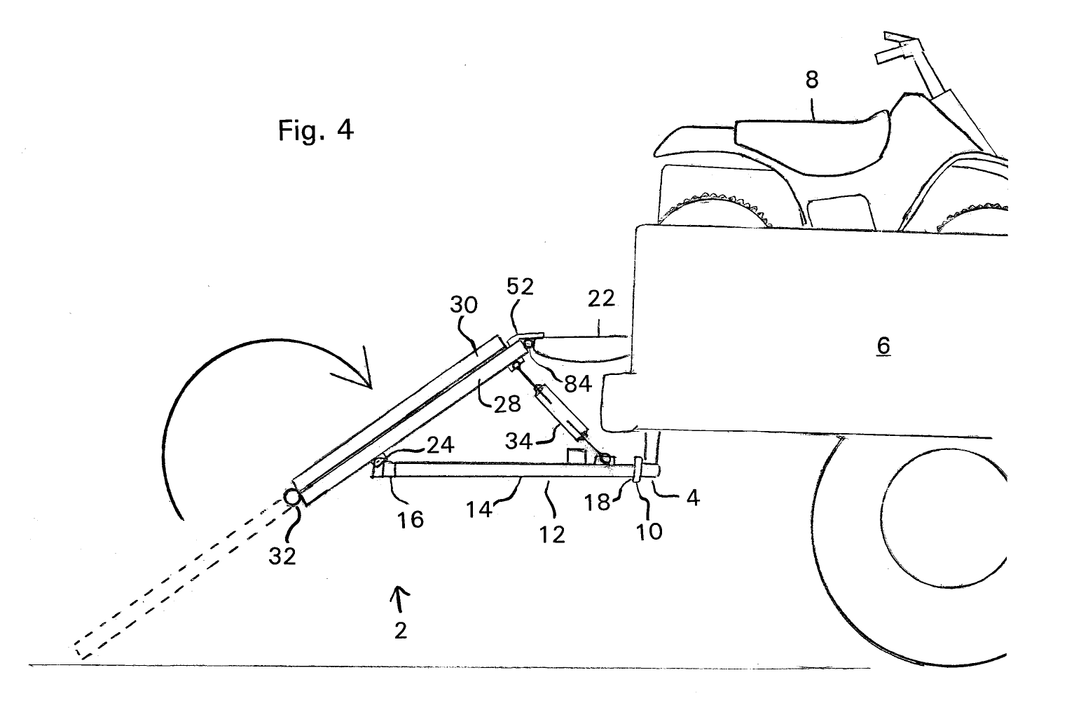

As best shown in FIG. 3, an adjustable member 34 is located between and extends from a first member aperture 36, provided in the undersurface 38 of the first ramp section 28, to a second member aperture 40 provided in the top surface 42 of the longitudinal beam 14. The adjustable member 34 comprises a first and second opposed threaded rods 44, 46 which each threadedly engage with an intermediate component 48. Each opposed end of the intermediate component 48 has an internal threaded bore which threadedly receives one of the threaded rods 44, 46. A first one of the internal threaded bores has a right hand thread while a second one of the internal threaded bores has an opposite left hand thread. Each of the opposed threaded rods 44, 46 having a similar or an identical thread. The remote free end of each of the threaded rods 44, 46 is curved, bent or otherwise contoured, e.g., has a bore, latch, or some other releasable connection feature, so as to facilitate secure attachment of the opposed end of the first threaded rod 44 to one of the first member apertures 36 provided in the undersurface 38 of the first ramp section 28 and attachment of the opposed end of the second threaded rod 46 with the second member aperture 40 provided in the top surface 42 of the longitudinal beam 14. It is to be appreciated that a plurality of spaced apart first and second member apertures 36, 40 may be provided along either the undersurface 38 of the first ramp section 28 and/or along the top surface 42 of the longitudinal beam 14 to facilitate arranging the adjustable member 34 in a desired orientation with respect to the main frame 12.

As a result of such configuration of the adjustable member 34, as the intermediate component 48 is rotated in a first rotational direction, such rotation causes the adjacent ends of the first and the second threaded rods 44, 46 to be drawn toward one another thereby decreasing the spacing between the undersurface 38 of the first ramp section 28 and the top surface 42 of the longitudinal beam 14, while rotation of the intermediate component 48 in the opposite rotational direction forces the adjacent ends of the first and the second threaded rods 44, 46 away from one another thereby increasing the spacing between the undersurface 38 of the first ramp section 28 and the top surface 42 of the longitudinal beam 14. The above described adjustment of the adjustable member 34 along with alignment of a desired through hole 20 of the longitudinal beam 14 with the aperture of the trailer hitch receiver 4, facilitates desired adjustment and/or alignment of the loading/unloading device 2 with the top surface of the tailgate 22 as well as the initial spacing between the first ramp section 28 and top surface of the longitudinal beam 14.

It is apparent from the above description, rotation of the intermediate component 48 can be used to adjust the relative position of the leading edge of the first ramp section 28 relative to a top surface of the tailgate 22 of the transport vehicle 6 so that the top surface of the loading/unloading ramp 26 and the top surface of the tailgate 22 can be precisely aligned with one another to facilitate safe and efficient loading and unloading of the desired off-road vehicle 8. In addition, as the off-road vehicle 8 travels up the loading/unloading ramp 26, as will be discussed below in further detail, the adjustable member 34 transfers the load and/or weight of the off-road vehicle 8 from the first ramp section 28 to the longitudinal beam 14 and then onto the trailer hitch receiver and transport vehicle 6 frame instead of transferring the weight of the off-road vehicle 8 to the tailgate 22, as with the prior art. It is to be noted, however, that for a brief distance, i.e., when the wheels of the off-road vehicle 8 are directly on top of the tailgate 22, some weight will be transferred from the off-road vehicle to the tail gate 22.

The leading end of the first ramp section 28 has a pair of spaced apart ears 52 which extend forwardly from the first ramp section 28 and are designed to overlap a portion of the top surface of the tailgate 22 (see FIGS. 1 and 3). These spaced apart ears 52 assist with properly aligning the top surface of the loading/unloading ramp 26 with the top surface of the tailgate 22 during the loading and unloading of the off-road vehicle 8. The spaced apart ears 52 can be welded, for example, to the leading end of the first ramp section 28 and are long enough so as to provide sufficient overlap with the tailgate 22 of the transport vehicle 6. Alternatively, the ears 52 can be pivotally attached to the first ramp section 28 so that the ears 52 can be rotated laterally away from the tailgate 22 to facilitate a downward pivoting motion of the first ramp section 28, as discussed below.

It is to be appreciated that if the adjustable member 34 is removed, such removal facilitates a pivoting motion of the first ramp section 28 downwardly against the top surface 42 of the longitudinal beam 14 and the main frame 12 (see FIG. 5). A pair of spaced apart conventional spring biased first locking pins 54 (see FIGS. 3 and 6) are supported by a transverse bar 56 of the main frame 12 for securing the first ramp section 28 in abutting engagement with the top surface 42 of the main frame 12 and retaining the loading/unloading ramp 26 is its fully stored position, as shown in FIG. 5. That is, each conventional spring biased first locking pin 54 has a retracted position in which the pin is retracted to thereby permit folding or unfolding of the first ramp section 28 onto or away from the top surface 42 of the main frame 12 and an extended position in which the pin is forced, by the spring, into a corresponding opening 58 provided in the first ramp section 28 to retain the first ramp section 28 in its folded position on the top surface 42 of the main frame 12, as shown in FIG. 5. It is to be appreciated that possibly a single heavy duty conventional spring biased first locking pin 54, mounted securely onto the top surface 42 of the main frame 12 may used to secure the first ramp section 28, in which case the transverse bar 56 may be eliminated.

In addition, the second ramp section 30 can be folded about the ramp hinge(s) 32 onto the first ramp section 28 (as shown in FIG. 4) into a partially stored position as this facilitates easy transport of the loading/unloading device 2 in a convenient manner. A pair of conventional spring biased second locking pins 60 are supported by opposed sides of the first ramp section 28, for example, for securing the second ramp section 30 in abutting engagement with the first ramp section 28, as shown in FIG. 4. That is, each conventional spring biased second locking pin 60 has a retracted position in which the pin is retracted to thereby permit folding of the second ramp section 30 onto and away from the first ramp section 28, and an extended position in which the pin is forced, by the spring, into a corresponding opening 62 provided in the second ramp section 30 to retain the second ramp section 30 in its folded condition on the top surface of the first ramp section 28, as shown in FIG. 4.

A handle 66 is provided on each opposed side of both the first ramp section 28 and the second ramp section 30 to facilitate both folding and unfolding of the first and the second ramp sections 28, 30 (see FIGS. 2A-2C, for example).

The top surface of the loading/unloading ramp 26 is generally a planar surface but, according to one embodiment, the top surface can be somewhat open or porous so as to allow dirt, snow, water, ice and other debris to pass readily there through while still providing a sufficient gripping surface which permits both loading and unloading of a desired off-road vehicle 8. In addition, a pair of guide tracks 68, generally spaced apart from one another by the width of the wheels of the off-road vehicle 8 to be loaded/unloaded, can be secured to or formed part of the top surface of both the first and second ramp sections 28, 30 to facilitate guidance of the off-road vehicle 8 during the loading and unloading process 6, as shown in FIG. 2C. Alternatively, In addition, a pair of spaced apart grooved guides 70, generally spaced apart from one another by the width of the skis of a snowmobile to be loaded/unloaded, and a center non-metal or textured surface 78 generally the width of a snowmobile tread, can be secured to or formed as part of the top surface of both the first and second ramp sections 28, 30 to facilitate guidance of the snowmobile during the loading and unloading process of a snowmobile onto the transport vehicle 6, as shown in FIG. 2B.

To facilitate both attachment of the loading/unloading device 2 to the trailer hitch receiver 4 of the transport vehicle 6 as well as detachment of the loading/unloading device 2 from the trailer hitch receiver 4 of the transport vehicle 6, each opposed side of the first ramp section 28 is provided with a pair of spaced apart hollow cylindrical sections 72 which each have a threaded aperture in a side wall thereof that matingly engages with a locking bolt 74. A support leg (not shown) passes through the center of each of the hollow cylindrical sections 72 and, once the threaded locking bolt 74 is sufficiently tightened against the respective support leg, the support legs providing a stable support which maintains the loading/unloading device 2 at a suitable height which facilitates both attachment of the loading/unloading device 2 to the trailer hitch receiver 4 as well as detachment of the loading/unloading device 2 from the trailer hitch receiver 4 of the transport vehicle 6.

If desired, as shown in FIG. 6, the main frame 12 of the loading/unloading device 2 can be provided with conventional brake lights 80 and turn signals 82 as well as a license plate holder 86 which facilitate attachment of the desired vehicle license plate to the loading/unloading device 2. The license plate holder 86 is normally provided with an illumination source to facilitate illumination of the license plate.

If desired, a rubber pad(s) 84 can be secured to or located between the leading end of the first ramp section 28 and the trailing end of the tailgate 22 (see FIGS. 3 and 4) so as to at least partially fill the gap between the leading end of the first ramp section 28 and the trailing end of the tailgate 22, to absorb load and also reduce the risk of scratching the surface of tailgate 22.

When the loading/unloading device 2 is in the position shown in FIG. 1, an off-road vehicle 8 can be loaded or unloaded onto the transport vehicle 6. Once loading of the off-road vehicle 8 has occurred and movement of the transport vehicle 6 is desired, the second ramp section 30 is pivoted about the ramp hinge(s) 32 so that the second ramp section 30 is folded over on top of the first ramp section 28 into its partially folded condition, shown in FIG. 4. Once the loading/unloading device 2 is in this position, the second locking pins 60 are extended into their extended positions so that the pins are forced, by the spring, into the corresponding openings 62 provided in the second ramp section 30 to retain the second ramp section 30 in its folded condition on the top surface of the first ramp section 28. Once in this position, it is possible for the transport vehicle 6 to travel down a road and transport the off-road vehicle 8 to another destination or location. In addition, if the adjustable member 34 is removed, such removal facilitates a pivoting motion of both the first and the second ramp sections 28, 30 downwardly against the top surface 42 of the longitudinal beam 14 and the main frame 12. Once the first and the second ramp sections 28, 30 are in this position, the first locking pins 54 are extended into their extended positions so that the pins are forced, by the spring, into the corresponding openings 58 provided in the first ramp section 28 to retain the first ramp section 28 in its folded condition on the top surface 42 of the main frame 12.

When deployment of the loading/unloading device 2 is desired, the above procedure is reversed.

Since certain changes may be made in the above described loading/unloading device, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, I claim:

1. A loading/unloading device for attachment to a trailer hitch receiver of a transport vehicle, the loading/unloading device comprising:
a main frame having a leading section which is sized to matingly engage with the trailer hitch receiver of the trailer hitch;
a loading/unloading ramp pivotly attached to the main frame by a main hinge such that a first portion of the loading/unloading ramp can, during use, matingly engage with a tailgate of the transport vehicle while the second opposed end of the loading/unloading ramp can engage with a ground surface; and
an adjustable member located between the loading/unloading ramp and the main frame for transferring weight from the loading/unloading ramp onto the main frame as an off-road vehicle is loaded onto or unloaded from the transport vehicle using the loading/unloading device.

2. The loading/unloading device according to claim 1, wherein the adjustable member comprises a first and second opposed threaded rods which each threadedly engage with an intermediate component so that rotation of the intermediate component, in a first rotational direction, causes adjacent ends of the first and the second threaded rods to be drawn toward one another while rotation of the intermediate component, in an opposite rotational direction, forces the adjacent ends of the first and the second threaded rods away from one another.

3. The loading/unloading device according to claim 1, wherein the loading/unloading ramp comprises a first ramp section and a second ramp section which are both hingedly connected together with one another along adjacent longitudinal edges of the first and the second ramp sections by at least one ramp hinge.

4. The loading/unloading device according to claim 1, wherein a leading end of the first ramp section has a pair of spaced apart ears which extend from the first ramp section and are arranged to overlap a portion of a top portion of a tailgate of the transport vehicle.

5. The loading/unloading device according to claim 1, wherein the main frame is generally T-shaped and comprises a longitudinal beam permanently connected with an intermediate section of a transverse beam.

6. The loading/unloading device according to claim 5, wherein a leading end of the longitudinal beam has a plurality of through holes which pass longitudinal through both opposed side walls of the longitudinal beam to facilitate alignment of the loading/unloading device with an aperture of the trailer hitch receiver of the transport vehicle.

7. The loading/unloading device according to claim 2, wherein the loading/unloading ramp has a length of between about 120 and about 60 inches and has a width of between about 72 and about 36 inches so that an inclination angle (a) of the loading/unloading ramp about 40 degrees or less.

8. The loading/unloading device according to claim 2, wherein the loading/unloading ramp comprises a first ramp section and a second ramp section which are both hingedly connected together with one another along adjacent longitudinal edges of the first and the second ramp sections by at least one ramp hinge; and
a remote free end of the first threaded rod is configured so as to facilitate secure attachment of the remote end of the first threaded rod with a first member aperture provided in an undersurface of the first ramp section and attachment of a remote free end of the second threaded rod with a second member aperture provided in a top surface of the main frame and transfer a load of the off-road vehicle from the first ramp section to the trailer hitch receiver and the transport vehicle.

9. The loading/unloading device according to claim 3, wherein each of the first ramp section and the second ramp section has a handle which facilitate both folding and unfolding of the first and the second ramp sections.

10. The loading/unloading device according to claim 1, wherein a top surface of the loading/unloading ramp is generally planar surface but sufficiently porous so as to allow dirt, snow, water, ice and other debris to pass readily there through while still providing a sufficient gripping surface which permits both loading and unloading of the off-road vehicle.

11. The loading/unloading device according to claim 10, wherein the top surface includes a pair of guide tracks which are spaced apart from one another so as to accommodate wheels of the off-road vehicle to be loaded/unloaded.

12. The loading/unloading device according to claim 10, wherein the top surface includes a pair of grooved guide which are spaced apart from one another so as to accommodate skis of the off-road vehicle to be loaded/unloaded.

13. The loading/unloading device according to claim 3, wherein each opposed side of the first ramp section is provided with a pair of spaced apart hollow cylindrical sections which each have a threaded aperture in a side wall thereof that matingly engages with a locking bolt, and a support leg passes through the center of each of the hollow cylindrical sections and, once the threaded locking bolt is sufficiently tightened against the respective support leg, the support legs providing a stable support which maintains the loading/unloading device at a suitable height which facilitates both attachment of the loading/unloading device to the trailer hitch receiver as well as detachment of the loading/unloading device from the trailer hitch receiver of the transport vehicle.

14. The loading/unloading device according to claim 1, wherein the loading/unloading device supports at least one of brake lights, a turn signal and a license plate holder.

15. The loading/unloading device according to claim 3, wherein at least one rubber pad is located between a leading end of the first ramp section and a trailing end of a tailgate of the transport vehicle so as to at least partially fill the gap between the leading end of the first ramp section and the trailing end of the tailgate.

16. The loading/unloading device according to claim 2, wherein the loading/unloading ramp comprises a first ramp section and a second ramp section which are both hingedly connected together with one another along adjacent longitudinal edges of the first and the second ramp sections by at least one ramp hinge, and the main frame has at least one spring biased first locking pins for retaining the first ramp section in a stored position in which the first ramp section extends substantially parallel to the main frame once the adjustable member is removed and the first ramp section is pivoted about the main hinge.

17. The loading/unloading device according to claim 3, wherein the first ramp section has at least one spring biased second locking pins for retaining the second ramp section in a stored position in which the second ramp section is folded about the ramp hinge and extends substantially parallel to the first ramp section.

18. A loading/unloading device for attachment to a trailer hitch receiver of a transport vehicle, the loading/unloading device comprising:
a main frame having a leading section which is sized to matingly engage with the trailer hitch receiver of the trailer hitch;
a loading/unloading ramp pivotly attached to the main frame by a main hinge such that a first portion of the loading/unloading ramp can, during use, matingly engage with a tailgate of the transport vehicle while the second opposed end of the loading/unloading ramp can engage with a ground surface, and the loading/unloading ramp comprising a first ramp section and a second ramp section which are both hingedly connected together with one another along adjacent longitudinal edges of the first and the second ramp sections by at least one ramp hinge;
an adjustable member located between the loading/unloading ramp and the main frame for transferring weight from the loading/unloading ramp onto the main frame as an off-road vehicle is loaded onto or unloaded from the transport vehicle using the loading/unloading device, the adjustable member comprising a first and second opposed threaded rods which each threadedly engage with an intermediate component so that rotation of the intermediate component, in a first rotational direction, causes adjacent ends of the first and the second threaded rods to be drawn toward one another while rotation of the intermediate component, in an opposite rotational direction, forces the adjacent ends of the first and the second threaded rods away from one another;
a leading end of the first ramp section having a pair of spaced apart ears which extend from the first ramp section and are arranged to overlap a portion of a top portion of a tailgate of the transport vehicle; and
a leading end of the longitudinal beam having a plurality of through holes which pass longitudinal through both opposed side walls of the longitudinal beam to facilitate alignment of the loading/unloading device with an aperture of the trailer hitch receiver of the transport vehicle.

19. The loading/unloading device according to claim 18, wherein a remote free end of the first threaded rod is configured so as to facilitate secure attachment of the remote end of the first threaded rod with a first member aperture provided in an undersurface of the first ramp section and attachment of a remote free end of the second threaded rod with a second member aperture provided in a top surface of the main frame and transfer a load of the off-road vehicle from the first ramp section to the trailer hitch receiver and the transport vehicle.

20. A method of loading/unloading an off-road vehicle using an loading/unloading device attached to a trailer hitch receiver of a transport vehicle, the method comprising the steps of:
sizing a leading section of a main frame to have a size which matingly engages with the trailer hitch receiver of the trailer hitch;
pivotally attaching a loading/unloading ramp to the main frame via a main hinge such that a first portion of the loading/unloading ramp can, during use, matingly engage with a tailgate of the transport vehicle while the second opposed end of the loading/unloading ramp can engage with a ground surface;
positioning an adjustable member between the loading/unloading ramp and the main frame; and
transferring weight of the off-road vehicle from the loading/unloading ramp onto the main frame as the off-road vehicle is loaded onto or unloaded from the transport vehicle using the loading/unloading device.
